(19) United States
(12) Patent Application Publication
(10) Pub. No.: US 2012/0185906 A1
(43) Pub. Date: Jul. 19, 2012

(54) Scalable Video Controls Bandwidth Allocation to Data Services

(75) Inventors: Peter-Jan Doets, Delft (NL); Martin Prins, Den Hague (NL); Victor Klos, The Hague (NL); Anton Havekes, Schiedam (NL); Robert-Ernst Kooij, Delft (NL); Hans Maarten Stokking, Wateringen (NL)

(73) Assignees: NEDERLANDSE ORGANISATIE VOOR TOEGEPAST -NATUURWETENSCHAPPELIJK ONDERZOEK TNO, Delft (NL); KONINKLIJKE KPN N.V., The Hague (NL)

(21) Appl. No.: 13/498,466

(22) PCT Filed: Sep. 30, 2010
(86) PCT No.: PCT/EP10/64520

§ 371 Date: Mar. 27, 2012

(30) Foreign Application Priority Data
Oct. 2, 2009 (EP) 09012512.1

(51) Int. Cl. H04N 21/24; H04N 21/643

(52) U.S. Cl. 725/109; 725/126

(57) ABSTRACT

An amount of bandwidth is allocated to a transport of content information as data via a data connection before initiating the transport. The content information is encoded in a layered coding scheme using a base layer and at least one enhancement layer. First it is determined if the data connection is in use for a further transport of further content information as further data via the data connection. Then one or more further attributes are determined of the further transport. Then, a number of the one or more enhancement layers of the content information are determined for the transport under control of a pre-determined policy depending on the one or more further attributes of the further transport.

### FIELD OF THE INVENTION

The invention relates to a method of allocating an amount of bandwidth to a transport of content information as data via a data connection. The invention also relates to control software, stored on a computer-readable medium for, when being run on a computer, controlling the allocation of an amount of bandwidth to a transport of content information as data via a data connection. The invention also relates to a data processing system, configured for control of allocating an amount of bandwidth to a transport of content information as data via a data connection.

### BACKGROUND ART

As known, the IP Multimedia Subsystem (IMS) is an architectural framework for delivering Internet Protocol (IP) multimedia services, e.g., Internet Protocol Television (IPTV). As known, IPTV is a digital television service that enables delivery of TV programs on a television set via a set-top box (STB) and through a high-speed Internet (broadband) connection. In order to facilitate functional integration of the IMS architecture with IP networks, such as the Internet, IMS uses standard Internet protocols, e.g., SIP (Session Initiation Protocol). SIP is a signaling protocol used for controlling multimedia communication sessions, e.g., voice calls and video calls using the IP. An IMS typically has a Resource Admission & Charging System (RACS). A RACS provides admission control. The RACS is configured for, e.g., checking the authorization of a subscriber requesting a service, checking the policy rules specific to the network operator involved, and checking whether the network resources (e.g., bandwidth) requested comply with the user profile of the subscriber and the current availability of the network resources, and if so, allocating the resources.

The network resources can be allocated in a variety of manners, such as fixing the amount of bandwidth; allocating a flexible amount of bandwidth with a guaranteed minimum; allocating a purely flexible amount of bandwidth (and using a best effort delivery policy); or requesting low latency (which is relevant to, e.g., gaming). For delivery of video and/or for enabling communication between two persons, network services typically require a minimum guaranteed amount of bandwidth for an acceptable quality of service (QoS) and/or an acceptable perceived quality of experience (QoE).

In practice, the amount of bandwidth available is limited, which may affect the QoS and/or availability of the service at the desired time. This is illustrated with the following scenarios.

In a first scenario, an end-user has his/her data processing equipment connected to a service provider via a dedicated link, e.g., an ADSL (Asymmetric Digital Subscriber Line) connection. This connection has a limited amount of bandwidth. If a service provider offers triple-play services: a video service (e.g., Internet television, video-on-demand (VoD)), a communication service (Voice-over-IP (VoIP), video conferencing, etc.) and an Internet service (e.g., accessing web pages, gaming), these services share the bandwidth of this user's single connection. Assume further that the total bandwidth of an ADSL2+ connection is, e.g., 12 Mbps (megabit per second), and that a video stream (e.g., a digital television channel) requires, e.g., 4 Mbps. If this user watches three video streams at the same time, he/she cannot use his/her Internet service or receive phone calls. Alternatively, if the user is using the Internet service or the telephone service, he/she cannot watch more than two television channels.

In a second scenario, multiple users share an amount of bandwidth, e.g., in a cable infrastructure (DOCSIS), in a home network connected to the Internet, or in a wireless infrastructure (GSM, UMTS or WiFi). As a result, not every user can use all available bandwidth. For clarity, the acronym “DOCSIS” stands for “Data Over Cable Service Interface Specification”, and refers to an international standard for defining the communications and operation support interface requirements for a data-over-cable system. The acronym “GSM” stands for “Global System for Mobile communication”, and relates to a cellular network for mobile telephones. The acronym “UMTS” stands for “Universal Mobile Telecommunications System” and refers to a third-generation mobile telecommunications technology relating to GSM. The acronym “WiFi” is the trademark of the Wi-Fi Alliance and relates to technologies for providing a data processing apparatus, e.g., a PC, a video game console, a mobile phone or an MP3-player, to connect to the Internet via a wireless network. If certain users were using most of the bandwidth, this would go at the expense of the amount of bandwidth available to other users. A current solution to this problem is to limit each individual user to a certain amount of bandwidth, and to divide the total available bandwidth among multiple users. Another solution relates to managing content information encoded in a hierarchical coding scheme of a base layer and one or more enhancement layers. A wireless access point can measure the radio channel in order to detect whether or not network losses (WiFi degradation) occur. On the basis of this measuring, the access point can decide to drop one or more enhancement layers in order to ensure that a base layer stream can be sent. Yet another solution is to re-negotiate a new session to adjust bandwidth usage.

KOFLER I ET AL: “Improving IPTV services by H.264/SVC adaptation and traffic control” BROADBAND MULTIMEDIA SYSTEMS AND BROADCASTING, 2009. BMSB '09 IEEE INTERNATIONAL SYMPOSIUM ON, IEEE, PISCATAWAY, NJ, USA, 13 May 2009 (2009 May 13), pages 1-6 discloses an intercepting RTSP/RTP proxy server performing admission control of the requested video based on the signalled scalability information, and decides whether the content can be streamed without changes or in an adapted version. The Hard Reservation Policy performs admission control and adaptation on the video streams and does not modify video bandwidth allocation after admission. The Flexible Borrowing Policy restricts the admission control to the base layer of the SVC stream, the packets carrying the enhancement layer data are marked with priorities and are handled at the network layer by a priority-based queuing mechanism.

Current resource admission systems solve the bandwidth problem by means of disallowing certain service requests if sufficient bandwidth cannot be allocated.

### SUMMARY OF THE INVENTION

The inventors now consider the scenario, wherein one or more services are provided to an end-user's data processing system via a managed data connection, e.g., a managed data network. In a managed data connection, admission control is being used to prevent overloading the data connection and to prevent congestion. A specific one of the services relates to providing, via the data connection, content information, e.g., video, audio, or multimedia. The content information is available in a layered coding scheme. As known, a layered video coding scheme comprises a base layer and one or more enhancement layers. The enhancement layers can be combined with the base layer for increasing, e.g., resolution, reproduction accuracy or frame-rate of the video content information when rendered. Video coding standards that use a layered coding scheme include Scalable Video Coding (SVC), MPEG-2, MPEG-4 ASP/FGS, H.263, H.263+, etc. The acronym “MPEG-4” refers to a standard scalable coding scheme for the compression of video data. In order to be able to cater to a variety of applications, ranging from low-quality, low-resolution applications to high-quality, high-resolution applications, the scheme has several profiles. Each profile can be used to tailor the scheme to the intended application. The most commonly deployed profiles are the Simple Profile (SP) and the Advanced Simple Profile (ASP). The ASP is an extended bandwidth version of the SP. The acronym “FGS” stands for “Fine Granularity Scalable Profile” and refers to an encoding technology that offers scalability. The combination of ASP and FGS is referred to as a “Streaming Profile”. Audio coding standards that use a layered coding scheme include MPEG-4 audio (AAC-SSR) and MPEG-4 SLS. The acronym “AAC” stands for “Advanced Audio Coding”, an audio compression format of the MPEG-2 and MPEG-4 specifications. The acronym “SSR” stands for “Scalable Sampling Rate”. The acronym “SLS” stands for “Scalable to Lossless Audio Coding”.

In an embodiment of the invention, a certain node of the connection is being monitored, e.g., the data processing equipment of one or more end-users, or the access points of the data processing equipment of the end-users to the data network. The data traffic at the node is monitored with respect to the number and types of data services currently being used. A policy control server is operative to adjust the bandwidth consumed by the data delivery of the content information in dependence on a pre-determined policy.

An embodiment of the invention relates to a method of allocating an amount of bandwidth to a transport of content information as data via a data connection before initiating the transport. The content information is encoded in a layered coding scheme. The layered coding scheme uses a base layer and at least one enhancement layer. The method comprises determining if the data connection is in use for a further transport of further content information as further data via the data connection. The method can also include determining one or more further attributes of the further transport. The method furthermore can comprise determining a number of the one or more enhancement layers of the content information for the transport under control of a pre-determined policy depending on the one or more further attributes of the further transport.

In this embodiment of the invention, one or more attributes of the further transport determine the amount of bandwidth to be allocated to the transport under control of a pre-determined policy. The pre-determined policy includes a set of rules, prepared in advance. The rules are applied to the further attributes determined in order to generate a result, based on which the number of the one or more enhancement layers is selected. Accordingly, by means of setting the number of enhancement layers of the content information in dependence on what is already being transported via the same data connection, the operator can optimize the accommodation of pieces of content information being transported via the same data connection, e.g., with respect to a number of pieces or with respect to load balancing. Of course, the number of enhancement layers supplied can be nil in case the bandwidth available for the transport is only sufficient for accommodating the base layer. Under these circumstances, the invention can only add one or more enhancement layers as soon as additional bandwidth becomes available to this particular content information stream.

The further attribute may include one or more of the following: a relative popularity of the further content information with respect to the content information, a semantic aspect of the further content information, a destination of the further data representative of the further content information being transported to the destination via the data connection; a source of the further data representative of the further content information, the time of the day of initiating the transport of the further content information, an identity of a further end-user of the further content information.

For example, if the relative popularity, or the relative priority, of the further content information is higher than that of the content information, the amount of bandwidth allocated to the transport of the content information will be lower than in case the content information has a higher relative popularity or a higher relative popularity.

The relative popularity is determined, e.g., on the basis of a respective number of requests of end-users for delivery of the respective content information. The number may be based on a history of end-user request for a population of end-users, or on expectations of the content provider. For example, a first IPTV broadcast of a live event, such as an inauguration of a head of state, or the finals of the UEFA Champions League, will be more popular than a second IPTV broadcast (on another channel) of a well-known movie. More people will be watching the first broadcast than the second broadcast. If the transport of the movie is initiated, a lower amount of bandwidth will be allocated than in case the transport of the live coverage of the inauguration is initiated.

As to the further attribute “semantic aspect”, assume that the content information, whose transport is to be initiated, is a TV program for children. The operator has determined a policy in advance with rules specifying that, in case the further content information is a movie, a lower bandwidth is to be allocated to the TV program for children than in case the further content information is a cartoon.

As to the attributes “destination” (e.g., end-user equipment at a specific data network address), some destinations may be regarded as more important than others. For example, assume that the destination of the further content information is a multicast server for further distribution of the further content information via a data network. A lower bandwidth is then allocated to the content information than in case the destination of the further content information is a receiver of an individual end-user.

As to the further attribute “source” (e.g., a content provider), a source may have arranged with the service provider to allocate more bandwidth to the transport of their content information than to the transport of other content from another source. Accordingly, the amount of bandwidth allocated to the transport of the content information, whose transport is to be initiated, is made dependent on the source of the further content information whose transport has already begun.

As to the further attribute “identity of the end-user”, some end-users may have paid premium subscription fees to the service provider for receiving content information with more enhancement layers than other end-users, given the bandwidth available. If the end-user of the further content information is a subscriber having paid the premium subscription fee, and the end-user of the content information is a subscriber having paid a lower subscription fee, a lower bandwidth may be allocated to the transport of the content information than in case the end-user of the content information were a premium subscriber.

As to the further attribute “time of the day”, assume that the time of transport of the further content information is at prime time, i.e., during the middle of the evening. As prime time is the time interval with the most viewers, broadcasters receive most of their advertizing revenues from programs broadcasted at prime time. Bandwidth may therefore be made more expensive at prime time than at other times. This can be translated into a business model, wherein less bandwidth is allocated to the content information, whose transport is to be initiated during prime time, than to the content information, whose transport occurs at other times.

In an embodiment of the method, the further content information is encoded in a further layered coding scheme. The further layered coding scheme uses a further base layer and one or more further enhancement layers. In the embodiment, the method comprises adjusting a further amount of bandwidth of the further transport. The adjusting comprises determining one or more attributes of the transport, and determining a further number of the one or more further enhancement layers of the further content information in the further transport under control of a pre-determined further policy depending on the one or more attributes of the first transport.

Again, the attributes may be of the same kinds as specified above for the further attributes, mutatis mutandis.

Note that the invention does not need to stop a transport session and to re-negotiate a new session for newly allocated resources, such as bandwidth. The transport session of the further content information continues, but one or more enhancement layers are blocked. Implementations of mechanisms for accomplishing this are discussed further below.

An advantage of the invention, compared to known approaches, resides in the ability to provide more content information delivery services, given a certain total bandwidth available at the data connection, and delivering higher quality when less content information is being consumed at any given time. For example, a bandwidth of 10 Mbps enables to fit two high-quality 4 Mbps video streams. If a third video stream is requested, all three streams could be delivered using a reasonable quality of 3 Mbps. Later, if one of the video streams is stopped, the situation returns to delivering two video streams, and both remaining streams can again be allocated a bandwidth of 4 Mbps each.

Other advantages relate to the following. A home network generally comprises different data processing devices, e.g., an STB, a network-enabled telephone, a computer with a network interface, etc. These devices are generally not aware of each other's presence. By managing the allocation of bandwidth dynamically in the access network and/or at the access node, these devices can stay unaware of each other whereas bandwidth usage can still be optimized. Managing the bandwidth allocation at the access node enables to also optimize bandwidth allocation among different home networks or multiple users receiving the electronic content information via a shared medium (e.g., cable, wireless). Instead of in the access network, the managing of bandwidth allocation can also be carried out at the residential gateway, for example, for services requiring data transmission from end-users to the core network, when uplink bandwidth resources are scarce. This is, for example, the case for user-generated content, or for video broadcasts originating from end-users.

In an implementation of the invention, the content information and the further content information are provided via an IMS architecture. As known, the IMS comprises a Policy and Charging Enforcement Function (PCEF) and a Policy and Charging Rules Function (PCRF). Details of the PCEF and PCRF will be discussed further below with reference to the drawings. The method comprises controlling the number of the one or more enhancement layers via the PCEF using gating of the one or more enhancement layers indicated by the PCRF. Accordingly, the invention uses existing building blocks in order to implement the bandwidth allocation.

With regard to the above implementations referring to an IMS architecture, it is remarked here that the invention can also be implemented in services provided via an infrastructure of a managed network other than the IMS architecture. Generally, in a managed network, the end-users are known in advance, and access to the managed network, as well as the communication via the managed network, are controlled. Such other managed networks likewise have functions that correspond to the ones discussed with reference to the IMS architecture: a first function that stores the end-user profiles such as information about individual addresses and subscriptions, log-in codes, access rights, etc; a second function for determining a control policy in order to decide on QoS management issues; and a third function for enforcing the policies determined by the second function. Of course, the nomenclature used in the specifications of the other managed networks (e.g., based on Digital Video Broadcasting (DVB)) to indicate the first, second and third functions, may be different from the one used in the IMS specification. However, within the context of the invention, the nomenclature of the IMS specification is used herein to describe the invention as applicable to managed network infrastructures in general.

Above embodiments give examples of the invention exploited as a method. Such method is commercially relevant to, e.g., a service provider or a network operator.

The invention can also be commercially exploited as control software, stored on a computer-readable medium. The control software is configured for control of allocating an amount of bandwidth to a transport of content information as data via a data connection before initiating the transport. The content information is encoded in a layered coding scheme. The layered coding scheme can use a base layer and at least one enhancement layer. The control software preferably comprises: first instructions for determining if the data connection is in use for a further transport of further content information as further data via the data connection; second instructions for determining one or more further attributes of the further transport; and third instructions for determining a number of the one or more enhancement layers of the content information for the transport under control of a pre-determined policy depending on the one or more further attributes of the further transport.

The computer-readable medium comprises, e.g., a memory implemented on a magnetic disk (e.g., a hard-disk) or on an optical disk (e.g., a CD-ROM), or a semiconductor memory (e.g., a memory stick or implemented as an integrated circuit chip).

The control software according to the invention can be commercially relevant to, e.g., a software provider or a set-maker. The control software can be installed on, e.g., a residential gateway, or an access node that provides access to a data network, a router, a network server, etc.

The control software can also be installed as distributed among a plurality of such entities in the data network that cooperate to implement the method of the invention under software control.

The control software may be in the form of source code, or of object code, or in the form of an intermediate code, being between source code and object code, such as code in a partially compiled format.

Further embodiments of the control software of the invention may have additional instructions, for example, instructions that control the execution of one or more steps occurring in various embodiments of the method in the invention, discussed in this description and/or specified in the appended dependent method claims.

The invention can also be commercially exploited as a data processing system, configured for control of allocating an amount of bandwidth to a transport of content information as data via a data connection before initiating the transport. The content information is encoded in a layered coding scheme. The layered coding scheme can use a base layer and at least one enhancement layer. The data processing system preferably comprises first means for determining if the data connection is in use for a further transport of further content information as further data via the data connection; second means for determining one or more further attributes of the further transport; and third means for determining a number of the one or more enhancement layers of the content information for the transport under control of a pre-determined policy depending on the one or more further attributes of the further transport.

The data processing system is accommodated, e.g., in a residential gateway, in an access node that provides access to a data network, in a router, in a network server, etc., or has its functionalities distributed among multiple such entities in the data network that are configured for cooperating in order to implement a method according to the invention.

The first, second and third means can be implemented in a variety of manners, e.g., as control software installed on a general-purpose computer in the data processing system, as dedicated hardware, such as dedicated electronic circuitry, or as a combination of software and hardware. Again, the first, second and third means can be distributed among multiple entities in the data network that cooperate to implement the method of the invention.

Further embodiments of the data processing system may have additional features, for example, features that are operative to carry out one or more steps of a method in the invention as discussed in this description and/or specified in the appended dependent method claims.

### BRIEF DESCRIPTION OF THE DRAWING

The invention is explained in further detail, by way of example and with reference to the accompanying drawing, wherein:

FIGS. 1 and 2 are block diagrams of a system in the invention;

FIG. 3 is a functional diagram of the system of FIG. 2;

FIG. 4 is a block diagram of only a part of a QoS management system in an IMS architecture;

FIG. 5 is a block diagram of an implementation of the system of FIG. 2 using the QoS management system of FIG. 4;

FIGS. 6, 7 and 8 are message flow diagrams illustrating the operation of the implementation in FIG. 5

FIG. 9 is another block diagram of a system in the invention;

FIGS. 10 and 11 are message flow diagrams illustrating the operation of the system of FIG. 9; and

FIGS. 12 and 13 are tables illustrating bandwidth allocation.

Throughout the Figures, similar or corresponding features are indicated by same reference numerals.

### DETAILED EMBODIMENTS

An embodiment of the invention relates to a method of controlling an amount of bandwidth consumed by content information, being delivered by a content information source in a first data service, via a data connection to data processing equipment. The source has the content information available encoded in a layered coding scheme involving a base layer and at least one enhancement layer. The data processing equipment has available a first pre-determined amount of bandwidth on the data connection. The method comprises controlling, according to a pre-determined policy, the number of enhancement layers in the content information delivered. The number is controlled in dependence on whether or not further data services are using the data connection and are consuming bandwidth.

FIG. 1 is a first block diagram of a system 100 in the invention. The system 100 comprises data processing equipment 102, a data connection 104 between the data processing equipment 102 and an access node 106, and a policy control server 108. The system 100 further comprises one or more session servers and/or one or more application servers, collectively represented in FIG. 1 by session/application servers 110.

The data processing equipment 102 is configured for receiving data services, among which content information (e.g., audio, video, multimedia), under control of the session/application servers 110 and via the data connection 104 and the access node 106. Examples of the data processing equipment 102 are a set-top box, a VoIP telephone, a personal computer (PC), and a home network. As known, a home network is a residential local-area data network (LAN), and is used to connect multiple electronic devices within the home. A home network can be connected to an external data network, e.g., the Internet or another wide-area network (WAN) via a residential gateway. Examples of a residential gateway are a DSL (digital subscriber line) router and a cable modem.

The access node 106 connects the core network (not shown) with the access network (not shown). The features “core network” and “access network” are well known in the art and will not be discussed here in further detail. The access node 106 is the last part of the core network and is often referred to as the point, which connects a plurality of end-users with their service provider via respective data connections, one of which is illustrated as the data connection 104. The data connection 104 is implemented as, for example, an optical fiber, a coaxial connection (e.g., a DOCSIS/cable), a copper wire connection (e.g., a DSL line) or a wireless connection (e.g., wireless LAN or WLAN). Typically, the access node 106 is a distribution point for multiple end-user connections. That is, thousands of, e.g., DSL subscribers are connected to a single access node. Owing to the large number of end-users thus connected, the data link (not shown) between the access node 106 and the core network has a high capacity (Gigabit/sec). The data connection 104 between the access node 106 and the data processing equipment 102 has a capacity in the range of from kilobytes per second to hundreds of megabytes per second, depending on, e.g., the technology implementing the various data links and on the service agreement with the end-user of the data processing equipment 102.

The session/application servers 110 provide, or otherwise control, the delivery of data services to their subscribers, such as to the end-user of data processing equipment 102. As known, a session server (e.g., an SIP/IMS server) is a server that keeps track of the session state information of end-users involved in a communication session conducted over a data connection. Examples of such sessions are an Internet telephone call, a video-conferencing session conducted over the Internet. An application server, e.g., an IPTV server, is a server that provides services for use by third parties, here the end-user(s) of the data processing equipment 102. Examples of data services provided by an application server are: providing live TV broadcasts, providing content-on-demand such as VoD, providing a Network PVR (Personal Video Recorder) for remote recording and storage of content information such as TV broadcasts, providing a video conferencing service, etc.

A specific one of the session/application servers 110 is configured to provide a data service to the data processing equipment 102. The specific service involves the communication of electronic content information that is supplied as data encoded in a layered coding scheme.

An example of electronic content information that can be delivered in a layered coding scheme is video. In a layered video coding scheme, the video information is encoded in a plurality of layers, a base layer plus one or more enhancement layers. When the video information is to be rendered, one or more enhancement layers can be combined with the base layer to increase, with respect to the only rendering the base layer, the resolution of the video, or the frame rate and/or to improve picture quality as perceived by the end-user. Layered video coding provides many advantages. It allows the same video to be decoded by data processing systems that differ in their data processing capabilities and performance. Layered video coding further allows the same video being displayed on display monitors of different screen sizes. Layered video coding also allows for providing a video service under different, dynamically changing, network conditions, e.g. available bandwidth, or interference on a wireless network. For example, the base layer can be made a protected layer that is guaranteed to be delivered via the data connection. This is accomplished by using a suitable delivery protocol for delivering the base layer of the video data, e.g., RTP (Real-time Transport Protocol) running over UDP (User Datagram Protocol). The enhancement layers of the video data are “nice to have” but they are usually not critical to the rendering of the video, and they can be supplied using another communication protocol, e.g., based on best-effort.

In operational use, the system 100 has information available about the data services being currently provided to the data processing equipment 102, for example, at the session/application servers 110, and/or at the access node 106, the latter as a result of traffic monitoring.

In an embodiment of the invention, the policy control server 108 obtains this information from the access node 106, or from the session/application servers 110 or from both. The policy control server 108 uses this information to determine how to manage the network resources at a certain location in the delivery path from the specific one of the session/application servers 110, which provides the electronic content information as data encoded in a layered coding scheme, to the data processing equipment of one or more end-users. The policy control server 108 determines the way of managing these network resources by means of applying a pre-defined, or automatically generated, policy for a single end-user or for multiple end-users, in order to provide dynamic allocation of bandwidth to the coding layers. Management of network resources takes place at that part of the data delivery path upstream of the location in the network, where insufficient bandwidth is available, i.e., the network bottleneck.

Operation of the system 100 is illustrated with an example of distributing layered content information such as a video. Any change in the data services, using the data connection 104, may be reason to adjust the number of layers used in the video distribution.

For example, if the data processing equipment 102 is processing two video streams, and the end-user of the data processing equipment 102 switches it back to the processing of a single video stream, the amount of bandwidth, previously used by the video stream now switched off, becomes available. The remaining video stream can, therefore, take up more bandwidth. As a result, the number of enhancement layers for the remaining video stream can be increased for a higher quality.

As another example, assume that the data processing equipment 102 is processing a video stream, and that the user of the data processing equipment 102 receives a phone call via the data connection 104. One or more enhancement layers of the video stream can be (temporarily) dropped to free up bandwidth for the phone call.

As another example, assume that the data processing equipment 102 is processing a video stream, and that the user of the data processing equipment 102 starts downloading an electronic file via the data connection 104. This downloading can be detected at, e.g., the access node 106, in response to which one or more enhancement layers can be dropped to speed up the downloading.

As still another example, if multiple devices within the data processing equipment 102 consume the same video, e.g., the devices have been tuned to the same IPTV channel, this particular video may include more enhancement layers than each one of different videos sent to different ones of the devices at the same time.

In order to be able to determine a way of managing the network resources, the policy control server 108 needs to be informed about, e.g., the bandwidth available to the data processing equipment 102, the kind of services currently being provided to the data processing equipment 102, including descriptions of the services, characteristics of the bandwidths required by the services, scaling a session involving the delivery of content information available in a layered coding scheme, coding layer characteristics, a number of the receivers receiving the content information, etc.

As to the criterion “bandwidth available to the data processing equipment 102”, this may refer to the total bandwidth available to the data processing equipment 102, or to the bandwidth available to the data processing equipment 102 only on a certain data link, e.g., only on a specific virtual LAN (VLAN). The bandwidth available to data processing equipment 102 can be determined in a variety of manners. For example, the available bandwidth can be measured at the access node 106. As another example, the bandwidth available can be measured at the data processing equipment 102 itself, e.g., at the home network. The policy server 108 obtains this information, e.g., by querying the residential gateway using SNMP (IETF RFC 1441 and RFC 2571) or retrieving the information with TR-069 (DSL Forum). The acronym “SNMP” stands for “Simple Network Management Protocol” and refers to a set of protocols for the monitoring, configuration and management of network devices. The acronym “IETF” stands for “Internet

Engineering Task Force”, and refers to an organization that develops and promotes Internet standards. The acronym “RFC” stands for “Request for Comments” and refers to a memorandum issued by the IETF. The indication “TR-069” stands for “Technical Report 069” and is a technical specification of the Broadband Forum. TR-069 defines an application layer protocol for remote management of end-user devices. As yet another example, the available bandwidth is determined based on bandwidth reservations for a certain VLAN minus the bandwidth used for all services provided to data processing equipment 102. The bandwidth measurements can be queried or polled via protocols such as: SNMP (IETF RFC 1441 and RFC 2571) or TR-069 (Broadband forum spec TR-69).

As to the criterion “the kind of services currently being provided to the data processing equipment 102”, this information is retrieved during session set-up and session negotiation in session description messages, for instance, with SIP in IMS-based networks, or with RTSP (Real Time Streaming Protocol) in IPTV-networks. With these protocols, session description messages such as SDP (RFC 2327) can be delivered. These messages contain meta-information about the (multimedia) session relating to transport protocols, network addressing, audio and video formats to be used, bandwidth requirements, etc.

As to the criterion “characteristics of the bandwidths required by the services”, this information can be exchanged via SDP descriptions during the session negotiations. The acronym “SDP” stands for “Session Description Protocol” and refers to a format for describing initialization parameters in an ASCII-string for streaming media. SDP describes multimedia (communication) sessions for the purpose of session announcement, session invitation, and parameter negotiation. Alternatively, the bandwidth requirements can be pre-defined or pre-configured by the service provider. For example, an IPTV service provider defines the bandwidth to be used for IPTV broadcast TV. The service provider knows the bandwidth requirements as he/she is in control of the IPTV encoder or as he/she has made arrangements with the party content provider providing the TV stream.

As to the criterion “scaling a session involving the delivery of content information available in a layered coding scheme”, the content information provider, e.g., the IPTV provider, has encoded the content information with a layered coding scheme. The content provider has therefore information about the relationship between, on the one hand, the number of enhancement layers used and, on the other hand, the perceived quality of the content information when rendered.

As to the criterion “coding layer characteristics”, the client (here: the data processing equipment 102) and the server (here: the specific one of servers 110 that supplies the content information encoded in a layered coding scheme) determine the parameters of the session during negotiation. The parameters include the number of layers, and the multicast addresses or unicast addresses used to distribute the layers. For example, the published Internet Draft from the IETF “RTP Payload Format for SVC Video”, draft-ietf-avt-rtp-svc-18.txt, editors S. Wenger et al., Mar. 6, 2009, specifies a variety of methods of distributing SVC video using RTP. A first method includes transmitting the layers as separate streams. Each respective one of the layers is then transmitted using a respective multicast address or, for unicast delivery, is transmitted using a respective unicast address and/or a respective port number. A second distribution method includes transmitting the layers as a combination of data streams. Different SVC layers are transmitted as a single RTP stream. Network Abstraction Layer (NAL) identifiers are used to determine the specific SVC layer to which an RTP packet payload belongs. A third distribution method includes a combination of the first and second distribution methods.

As to the criterion “usage of the content information”, the usage can be determined by means of analyzing the session set-up. The session set-up gives rise to an exchange of messages between the data processing equipment 102 and the specific one of the servers 110 that supplies the content information as data that is encoded in a layered coding scheme. Consider, for example, the scenario of IPTV. SIP messages and/or RTSP messages contain information about the requested TV channel. An IGMP group join message can be translated to a TV channel. An IGMP group join message is sent by a host, e.g., the data processing equipment 102, when the host intends to join a multicast group for receiving the encoded content information supplied in the multicast group. Alternatively, the usage of the content information can be determined by means of snooping the data network traffic. Yet another way of determining the usage of the encoded content information is analyzing the data network management. For example, a service provider can forward the logging information of a specific STB, e.g., data processing equipment 102, to the core network for purposes of managing the data network. The TV channel being watched can be determined on the basis of this logging information. The acronym “IGMP”, used above, stands for “Internet Group Management Protocol” and refers to a communication protocol for managing the membership of Internet Protocol Multicast groups. IGMP is an integral part of the IP multicast specification and is used by IP hosts and adjacent multicast routers in order to create multicast group memberships. For clarity: in IP version 6 (IPv6), requests for membership of a network multicast are not handled by IGMP. Instead, the Multicast Listener Discovery (MLD) protocol (IETF RFC 2710) or the MLD protocol version 2 (RFC 3810 and RFC 4604) are being used. In MLD terminology, a multicast group join message is called a “Multicast Listener Report”.

Based on above criterions, the policy control server 108 determines a policy for managing the network resources involved in consumption of bandwidth in the data connection 104 to the data processing equipment 102. This policy needs to be enforced in order to take effect. In the invention, policy enforcement is used to controllably drop or pass data packets that contain data of a particular enhancement layer of the encoded content information. The policy as determined can be enforced at different locations in the distribution network.

As an example, the policy is enforced at the residential gateway of the home network at the data processing equipment 102. The residential gateway manages layered content information streams in the uplink direction. A typical example is allowing multiple users to broadcast SVC video to the Internet (to an application server), when uplink resources are sparse.

As another example, the policy is enforced at the access node 106. This approach is feasible in a scenario wherein the layered content information is destined for multiple pieces of data processing equipment of different households, among which is the data processing equipment 102, sharing the same data connection 104. For example, multiple households share the bandwidth of the data connection 104 (e.g., as in a DOCSIS network). The same approach is feasible in another scenario, wherein the layered content information is destined for multiple users in one household, i.e., multiple users simultaneously using the data processing equipment 102. The bandwidth of the data connection 104 is then shared between multiple users of the same data processing equipment 102, e.g., a home network.

As still another example, the policy is enforced at a network node, e.g., a router (not shown). The network node is then configured for managing the layered content information destined for multiple access nodes, among which is the access node 106, or for multiple households or for multiple end-users. For example, the managing of the layered content information destined for multiple access nodes includes optimizing the core network's usage for distribution of multicast IPTV channels.

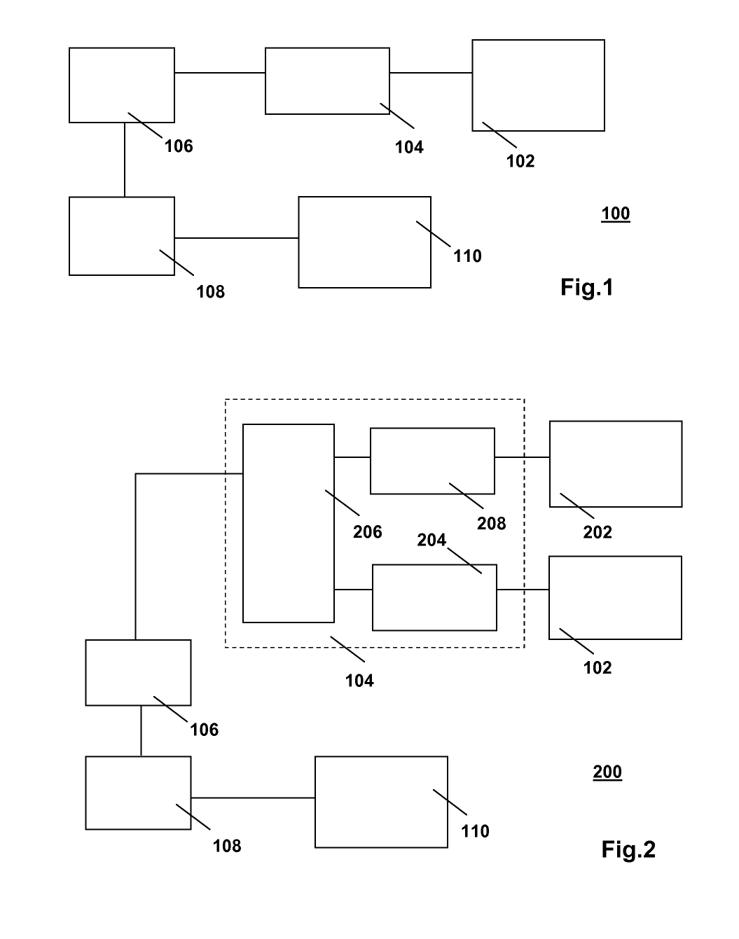

FIG. 2 is a second block diagram of a system 200 in the invention, illustrating a scenario wherein multiple households or multiple users share bandwidth. The system 200 comprises components of the system 100, discussed above with reference to FIG. 1: data processing equipment 102, the data connection 104, the access node 106; the policy control server 108 and the session/application servers 110. The system 200 also comprises one or more further pieces of data processing equipment, e.g., data processing equipment 202. The data connection 104 is implemented as coupling the data processing equipment 102 to the access node 106 via a data link 204 and an access network 206, and coupling the data processing equipment 202 to the access node via a data link 208 and the access network 206.

Sharing of bandwidth in the access network occurs, e.g., in a cable infrastructure (e.g., DOCSIS) and in many wireless systems (GSM/UMTS, WiFi, WiMax, LTE, DVB-H, etc.). The acronym “WiMax” stands for “Worldwide Interoperability for Microwave Access” and refers to a technology, based on the IEEE 802.16 standards for wireless data transmission from point-to-multipoint links to portable and fully mobile internet access. The acronym “LTE” stands for “Long Term Evolution” and refers to the fourth generation mobile broadband standard, successor to UMTS (a third generation technology). The acronym “DVB-H” stands for “Digital Video Broadcasting-Handheld” and refers to a standard of a mobile TV format.

Operation of the system 200 is illustrated with the following example. Consider an IPTV multicast service, wherein multiple users watch the same program on the same TV channel delivered by the multicast. The users do not individually receive an individual stream for the same TV channel. However, the stream is put on the shared access network 206 only once, thus taking up only the bandwidth needed for a single stream. Consider the scenario, wherein multiple users watch the same program on a first TV channel, and wherein another user watches another program on a second TV channel. In order to maximize the average quality of the TV service as perceived by the group consisting of the multiple users and the other user combined, the program on the first TV channel is delivered with more layers than the program on the second TV channel. That is, the bandwidth allocated to the multicast delivery of the first program is higher than the bandwidth allocated to the delivery of the second program.

The actual scaling of the content information, e.g., a video stream, is carried out by means of adding enhancement layers or removing enhancement layers. Layers can be dropped by activating a firewall mechanism or a gating mechanism, under control of a policy based on one or more of the criterions mentioned above in order to determine which enhancement layers to drop. The firewall mechanism or gating mechanism is de-activated if enhancement layers are to be added.

The scaling can be implemented in a variety of manners, depending on the mechanism used to transport the data.

For example, one or more layers are transported, each individual layer per individual RTP stream. Different multicast addresses are used per layer. For unicast, the streams are both from different source port numbers and to different destination port numbers. The receiving client is to be notified of which one of the layers is contained in which one of the streams in order to properly process the streams. This information is provided in, e.g., an SAP announcement. The acronym “SAP” stands for “Session Announcement Protocol” and refers to a computer protocol for broadcasting multicast session information. Alternatively, the information about which layer is contained in which stream is provided in the session negotiation between client en server.

As another example of implementing the scaling, one or more layers are transported, each individual layer per individual Network Abstraction Layer (NAL) used in the H.264/AVC Video Coding Standard. A NAL is then considered a container usable in RTP to transport different media in a single RTP stream. Each NAL has its own identifier, which is part of the RTP headers.

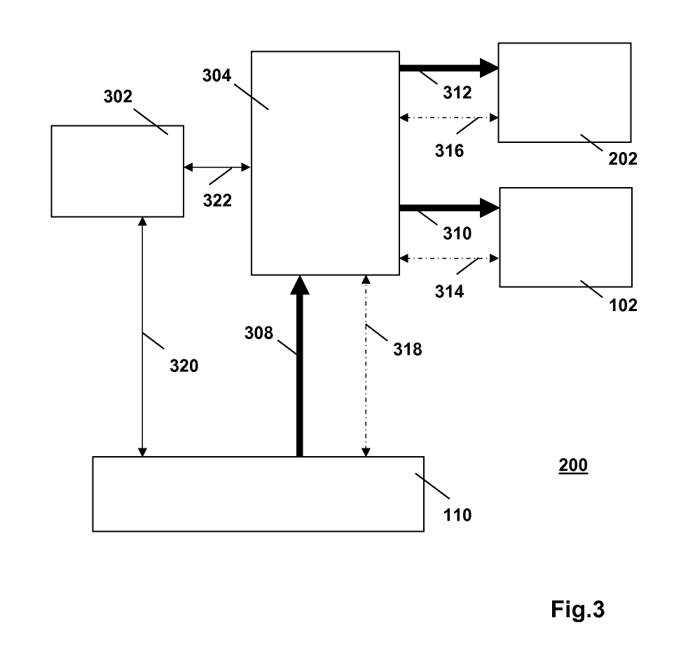

FIG. 3 is a diagram of system 200, discussed above with reference to FIG. 2, illustrating functional aspects of the invention. As discussed above, the data processing equipment 102 and the data processing equipment 202 receive content information that is available at the session/application servers 110 as encoded in a layered coding scheme. A policy control function 302 and a policy enforcement function 304 are implemented between, on the one hand, the session/application servers 110 and, on the other hand, the data processing equipment 102 and the data processing equipment 202.

The policy control function 302 has been discussed above with reference to the policy control server 108 in systems 100 and 200.

The flow of the content information data, from the session/application servers 110 to the data processing equipment 102 and the data processing equipment 202, is subjected to the policy enforcement function 304. The policy enforcement function 304 enforces the policy determined by the policy control function 302. Enforcement of the policy results in selectively passing on or selectively stopping one or more enhancement layers of the encoded content information, e.g., by selectively dropping or forwarding data packets containing the data of a specific enhancement layer. The flow of the content information data from the session/application servers 110 is indicated by an arrow 308 between the session/application servers 110 and the policy enforcement function 304. The flow of the content information to the data processing equipment 102 is indicated by an arrow 310 between the policy enforcement function 304 and the data processing equipment 102, and the flow of the content information to the data processing equipment 202 (not necessarily the same as the content information flowing to the data processing equipment 102) is indicated by an arrow 312 between the policy enforcement function 304 and the data processing equipment 202. The data flow from the session/application servers 110 to the data processing equipment 102 and to the data processing equipment 202 is subjected to the policy enforcement function 304. The signal paths indicated by arrows 314, 316 and 318 are the communication paths involved in setting up the sessions to enable the data processing equipment 102 and the data processing equipment 202 to receive the content information available from the session/application servers 110. The arrow 314 connects the data processing equipment 102 and the policy enforcement function 304. The arrow 316 connects the data processing equipment 202 and the policy enforcement function 304. The arrow 318 connects the policy enforcement function 304 and the session/application servers 110. The signal paths indicated by arrows 320 and 322 are the communication paths involved in determining the relevant policy to be applied and controlling the enforcement of the policy determined. The arrow 320 connects the session/application servers 110 and the policy control function 302. The arrow 322 connects the policy control function 302 and the policy enforcement function 304.

Implementation examples of the policy enforcement function 304 have been discussed above.

The invention is in particular applicable to managed data networks, i.e., data networks with policy control and admission control. A first example implementation of the invention, discussed in detail below, illustrates dynamic layer-aware bandwidth management using the standardized Policy and Charging Control (PCC) in the QoS infrastructure of the IMS architecture in an IPTV context. A second example implementation of the invention, discussed in detail below, illustrates dynamic layer-aware bandwidth management based on RTSP snooping in the access node 106, also in an IPTV context. Instead of, or in addition to RSTP snooping at the access node 106, an RTSP proxy can be used. The user then connects not directly to the IPTV sever, but indirectly via the RTSP proxy. The term “snooping” refers to a process of listening for specific network traffic, with the purpose of capturing certain network messages and (optionally) preventing the message from proceeding to its destination. Snooping is used in the case that a network node between source and destination needs to intervene in the data traffic flowing between source and destination, for instance, in order to alter the network message contents (e.g., for RTSP) or to prevent the transmission of redundant protocol messages (e.g., for IGMP).

As to the first example implementation using the PCC of the IMS architecture, reference is made to the following published specifications: a first specification “ETSI TS 182 027 TISPAN IPTV Architecture: IPTV functions supported by the IMS subsystem”, version 2.0.0 (IMS-Based IPTV release 2); and a second specification “3GPP TS 23.203 Policy and Charging Control architecture”, version v9.0.0. The first specification describes how the end-user equipment, e.g., the data processing equipment 102 in FIG. 1, can request and terminate video streams. The second specification describes how QoS is being managed. QoS management is also called “policy based management”, consisting of policy control (making decisions about what actions to take) and policy enforcement (taking actions in accordance with the decisions). The second specification is quite similar to another specification about the Resource and Admissions Control Sub-System (RACS): “ETSI ES 282 003 TISPAN Resource and Admission Control Sub-System”, version v2.0.0.

The first example implementation (using the PCC of the IMS architecture) will now be discussed. Consider the following scenario. A first person in a household starts watching a first video being received as a first video stream. Thereafter, a second person in the household starts watching a second video, being received as a second video stream. After some time, the first person stops watching the first video. Technically, the following process is carried out. The first person starts watching the first video. The first video stream comprises video data encoded in a layered coding scheme. There is enough bandwidth available and all layers (base layer and one or more enhancement layers) are being used for maximum quality as perceived by the first person. Then, the second person starts watching the second video. Now, there is not enough bandwidth available for the second video stream. In order to free up bandwidth for the second video stream, one or more enhancement layers of the first video stream are blocked, as a result of which the quality of the first video is reduced. After some time, the first person stops watching the first video. The bandwidth used by the first video stream becomes available. The quality of the second video will be increased by adding one or more enhancement layers of the second video.

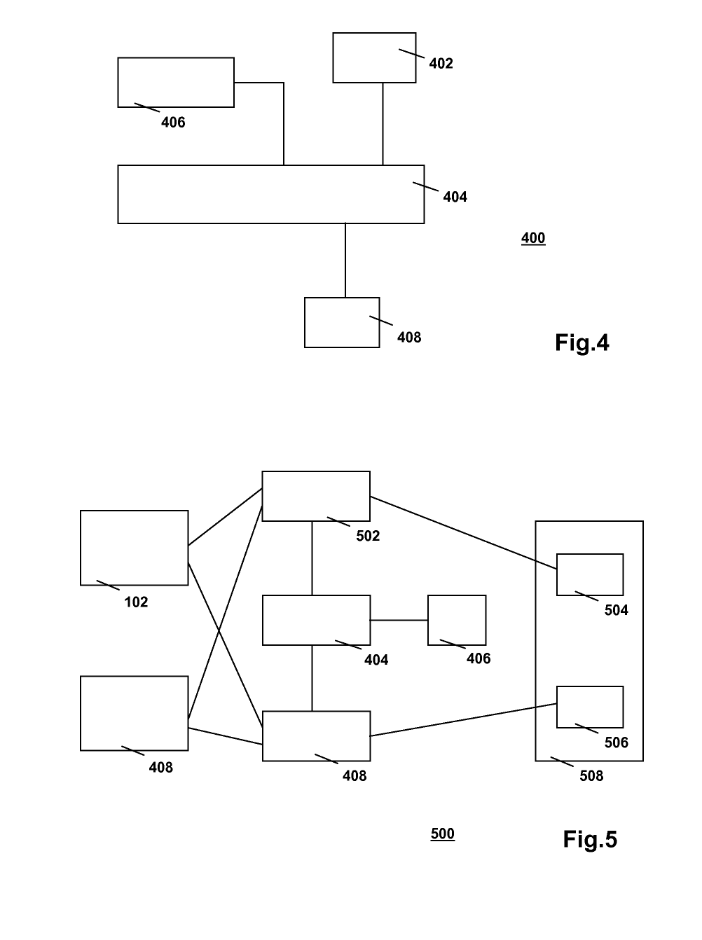

FIG. 4 is a block diagram of only a part of a known QoS management system 400 in order to illustrate the first example implementation of the invention using the PCC of the IMS architecture. The QoS management system 400 comprises the following components: an Application Function (AF) 402, which handles SIP messages and which forms actually a part of the IMS core; an entity 404 referred to as “Policy and Charging Rules Functions” (PCRF), which is the policy control function, containing rules to make decisions on QoS management; a Subscription Profile Repository (SPR) 406, containing user profiles, optionally including user-specific rules or user-specific information used for making decisions on QoS management with respect to one or more specific ones of the end-user; and a Policy and Charging Enforcement Function (PCEF) 408, which carries out the QoS policies decided upon by the PCRF 404. The PCRF 404 is functionally connected to the SPR 406, to the AF 402, and to the PCEF 408.

QoS policies regarding bandwidth management include rules on allowing a certain amount of bandwidth for certain sessions, and also include so-called gating functions, completely allowing or disallowing certain streams of data packets. In order to be able to identify a stream of data packets, so-called 5-tuples can be used as labels for IP data packets. A 5-tuple for a certain IP data packet consists of: the IP address of the origin of the data packet (also referred to as the “source IP address”); the port number of the origin of the data packet (also referred to as the “source port”); the IP address of the destination of the data packet (also referred to as the “destination IP address”); the port number of the destination of the data packet (also referred to as the “destination port”; and an identification of the application protocol used. Alternatively, in order to be able to identify a data stream, deep-packet inspection can be applied to data packets in the PCEF 408. This allows for a more fine-grained control. The PCEF 408 can analyze the data packets in order to determine details of application protocols. An example of this approach is looking up the RTP details, which can provide information on the layers of the encoded video.

FIG. 5 is another block diagram of a system 500 that combines elements of the system 200 of FIG. 2 and elements of the known QoS management system 400 of FIG. 4. The first data processing equipment 102 and the second data processing equipment 202 share the data connection 104 (not shown here) as they belong to the same household. Each of the first data processing equipment 102 and the second data processing equipment 202 is connected to the Core 502 of an IMS system. The first data processing equipment 102 and the second data processing equipment 202 exchange SIP messages with the Core IMS 502. SIP messages are also exchanged between the Core IMS 502 and a Media Control Function (MCF) 504. The actual media (here: video) data is delivered by a Media Delivery Function (MDF) 506 via the PCEF 408 to the first data processing equipment 102 and the second data processing equipment 202, using RTP for carrying the media data packets. The MCF 504 and the MDF 506 are elements of a Media Function (MF) 508. The MF 508 is part of the IPTV environment that provides IPTV and VoIP streaming services. An IPTV service function supports live TV streaming, delivered over IP multicast and/or unicast, and remote video recording and VoD, which are delivered over IP unicast. The MCF 504 controls the MDF 506. The MCF 504 combines session control and media control. The session control sets up SIP IPTV sessions (via SIP INVITE, REFER) and the media control selects the corresponding media delivery function or media storage function for carrying out the delivery of the media stream. The Core IMS 502 is connected to the PCRF 404 using the Diameter protocol. The Diameter protocol is a computer networking protocol for authentication, authorization and accounting, and is defined by the standard IETF RFC 3588. The PCRF 404 is connected to the SPR 406 and to the PCEF 408, also using the Diameter protocol. For more background information and implementation details, please see the first and second specifications mentioned above.

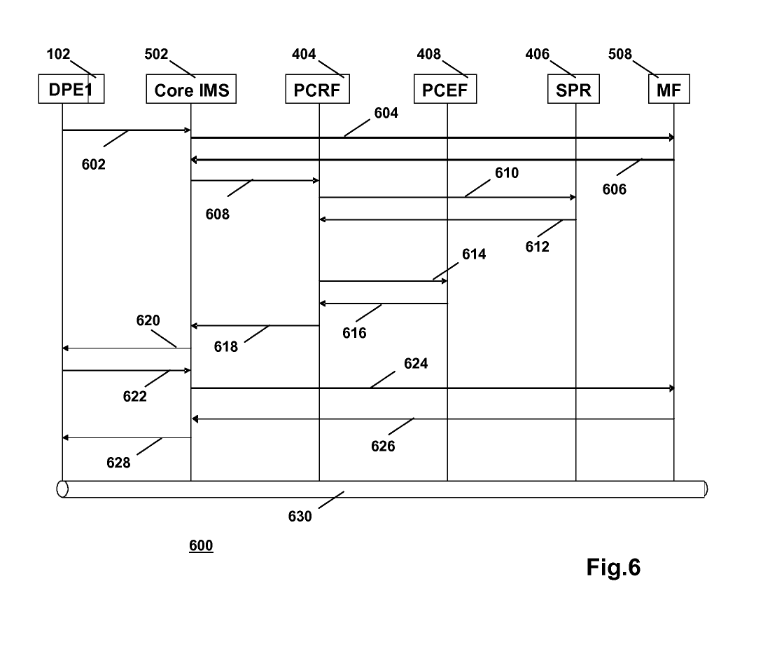

FIG. 6 is a first signaling diagram 600 illustrating the flow of messages in the system 500 involved in the media control and media delivery regarding the first data processing equipment 102. It is assumed here that the first data processing equipment 102 is connected to the network and is registered with the IMS service provider, according to ETSI TS 182 027. It is also assumed that the second data processing equipment 202 is inactive, i.e., the second data processing equipment 202 does not consume bandwidth of the shared connection. In the first signaling diagram 600, the first data processing equipment 102 is indicated by the abbreviation “DPE1”.

The first person is using the first data processing equipment 102 and requests a broadcast session. In a step 602, the DPE1 102 sends a session initiation request to the Core IMS 502. In a step 604, the Core IMS 502 forwards the session initiation request to the appropriate MF 508. In a step 606, the MF 508 sends a media offer, containing details concerning the media, e.g., codecs used, to the Core IMS 502. The Core IMS 502 requests resources from the network, based on this media offer. In a step 608, the Core IMS 502 sends therefore a resource request message to the PCRF 404. In a step 610, the PCRF 404 requests the user profile from the SPR 406, and receives this profile in a step 612. Based on the profile received, the PCRF 404 can make a decision concerning the requested resources. In this case the PCRF 404 decides that the request be allowed. In a step 614, the PCRF 404 sends a resource request to the PCEF 408. In a step 616, the PCEF 408 confirms the allocation of the resources to the PCRF 404. In a step 618, the PCRF 404 confirms the resource allocation to the Core IMS 502. After the allocation of the resources has been confirmed, the media offer is sent to the DPE1 102 in a step 620. The DPE1 102 selects the proper format and sends in steps 622 and 624 a media answer via the Core IMS 502 to the MF 508. After this, the MF 508 confirms, via the Core IMS 502 to the DPE1 102, with a session initiation response in a step 626 and a step 628, that the session has been established. Next, media control and delivery can take place between DPE1 102 and the MF 508, e.g. using the Real Time Steaming Protocol (RTSP) for media control (please see IETF RFC 2326) and the RTP protocol for media delivery (please see IETF RFC 3550). For multicast IPTV streams, media control is often limited to starting the streams and stopping the streams. This is typically achieved using IGMP instead of RTSP. The media control and delivery stage is indicated with reference numeral 630.

The first signaling diagram 600 shows the communication between the PCRF 404 and PCEF 408 as involving a “resource request” and a “resource response”. In practice, this communication can be implemented in a variety of manners, depending on which type of policy enforcement is available. The resource request and the resource response are usually concerned with bandwidth reservation.

As an alternative to the example discussed above, gating can be used. The term “gating” refers to the operation of entirely blocking certain data streams, and is comparable to the way a firewall works. Any data stream identified can be gated. For a video encoded in a layered coding scheme, gating can be used to block the data streams of certain layers and to allow the data streams of other layers to pass. In order to control the process of gating, the PCRF 404 does not send a simple resource request, but sends instead, e.g., a gating request containing the information needed to identify the relevant data stream. Another approach is that the PCRF 404 uses pre-defined policies in the PCEF 408, and that the PCRF 404 only sends a policy control message indicating the required policy to be set.

As mentioned in above scenario, the second person in the same household requests streaming a second video, while the first person is watching the first video being streamed in the session, which has been set up according to the message flow discussed with reference to the first signaling diagram 600. However, there is now not enough bandwidth for this second video available. For example, streaming the first video takes up 6 Mbps of bandwidth, and streaming the second video also takes up 6 Mbps, whereas the total bandwidth available is limited to 10 Mbps.

One could solve this somewhere in the Core IMS 502, e.g. in an IMS application server (not shown). An approach could be the following. The request for the second video will first be denied. After this, a renegotiation of the media offer is necessary for the first video, after which a renegotiation for the second video takes place. This a very complex process that requires a large amount of signaling messages. Specification IETF RFC 3725 gives some message flows that can serve as guideline for this. For the data processing equipment 202 of the second user a session set-up process can be used that is the same as for the data processing equipment 102 of the first user. As there is not enough bandwidth available for the second media stream, the media stream to the first data processing system 102 needs to be adjusted. The PCRF 404 determines that the media supplied to the first data processing system 102 needs to give up some bandwidth, and notifies the Core IMS 502. The Core IMS 502 modifies the session of the first data processing system 102 by means of sending messages to the MF 508, to the first data processing system 102, and to the PCRF 404. As a result the PCRF 404 and the PCEF 408 do indeed modify the resources.

This method for downscaling the bandwidth of a standing session has disadvantages. A first disadvantage is that this method is not network-efficient, in the sense that it needs many signaling messages to be sent over the network. A second disadvantage is that many components across the whole system are involved in modifying the standing session, and each of these components needs to be capable of supporting this particular method of downscaling. A third disadvantage is that it takes some time to complete the downscaling using above method. The signaling messages go back and forth over the network, and cause delays during the session setup for the second data processing equipment 202. The number of signaling messages involved is almost doubled compared to the number required for a regular session set-up, as discussed with respect to the first data processing equipment 102. The responsiveness of the media service, as perceived by the second user, will be much worse than the responsiveness experienced by the first user. Consider within this context a user who is quickly switching (i.e., zapping) TV channels. A slow responsiveness of the TV service while the user is zapping will be perceived by the user as a drawback.

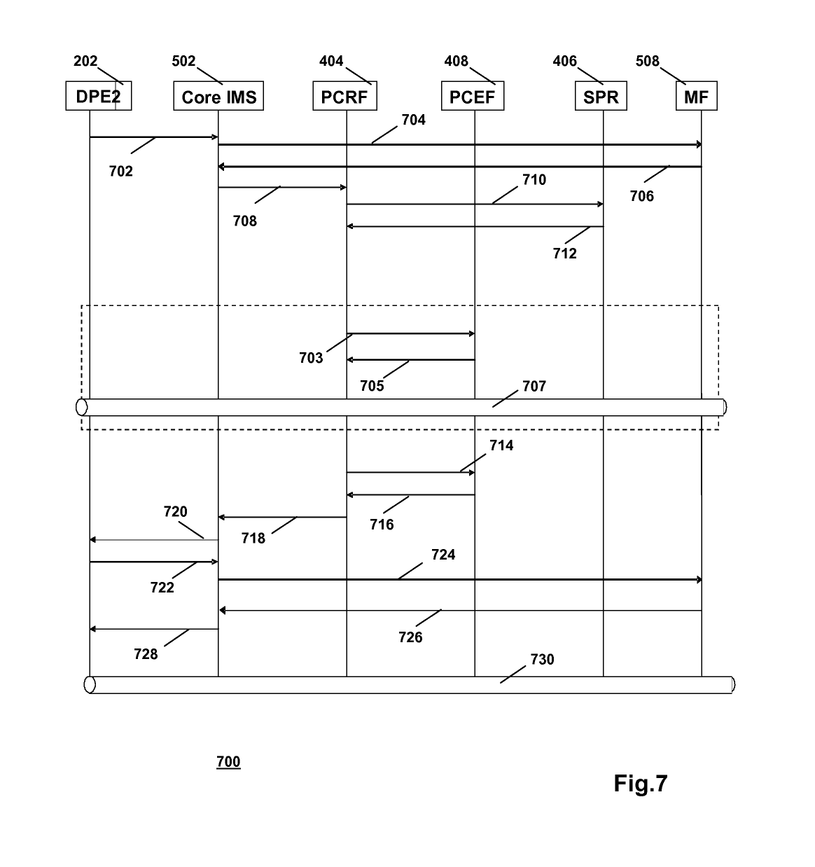

FIG. 7 is a second signaling diagram 700 illustrating the invention with reference to the flow of messages in the system 500 involved in the media control and media delivery regarding the second data processing equipment 202 requesting the second video, when the first data processing equipment 102 is already involved in receiving the first video. In the second signaling diagram 700, the second data processing equipment 202 is indicated by the abbreviation “DPE2”.

The second signaling diagram 700 comprises steps 702, 704, 706, 708, 710 and 712, executed by, or on behalf of, the DPE2 202. The steps 702-712 are the counterparts to the steps 602-612 in the first signaling diagram 600 executed by, or on behalf of, the DPE1 102. That is, the message flow for the DPE2 202 is the same as for DPE1 102 up to, and including step 712. When the process has arrived at the stage, wherein PCRF 404 has to decide about the allocation of resources, PCRF 404 determines that not enough bandwidth is available to also honor the request from the DPE2 202. PCRF 404 then decides to reduce the amount of bandwidth allocated to the DPE1 102, and to allocate an amount of bandwidth to the DPE2 202 that is lower than requested.

The media streams consist of video encoded in a layered coding scheme; bandwidth can be reduced by dropping one or more enhancement layers. The PCEF 408 uses its gating functionality in order to block one or more enhancement the layers as indicated by the PCRF 404. In the example scenario, the bandwidth allocated to DPE1 102 will be reduced to 5 Mbps from the maximum of 6 Mbps, and the bandwidth allocated to the DPE2 202 will be 5 Mbps.

The bandwidth re-adjustment in the service to the DPE1 102 is accomplished in a step 703 and a step 705, carried out after the step 712. In the step 703, the PCRF 404 sends a resource modification message to the PCEF 408, with an instruction for PCEF 408 to readjust the amount of bandwidth currently allocated to the DPE1 102. The modification message contains the information needed to identify the enhancement layers to be blocked in the first video delivered to the DPE1 102. This is called a resource modification here, but it could equally well be called new policy control instructions or new gating instructions for PCEF 408. See the discussion of the first diagram 600 above. In the step 705, the PCEF 408 confirms to the PCRF 404 that the resource modification has been executed. The result of the actions, taken by PCEF 408, is that the DPE1 102 receives fewer layers of video data than previously, as a result of which the first user will experience a reduction in quality. This stage is indicated with reference numeral 707 and is depicted between the step 705 and a step 714, discussed below. As for the DPE2 202, part of the resource modification request include further instructions to block certain enhancement layers in the second video stream requested by the DPE2 202. Note that DPE1 is not actively involved in this process.

Steps 714, 716, 718, 720, 722, 724, 726 and 728 in the second signaling diagram 700 correspond to the steps 614, 616, 618, 620, 622, 624, 626 and 628 of the first signaling diagram 600, now performed on behalf of, or by, the DPE2 202, and are not discussed in further detail here. In the steps 726 and 728, the MF 508 confirms, via the Core IMS 502 to the DPE2 202, with a session initiation response, that the session has been established. After this, a stage 730 has been reached wherein the control and delivery of the media to DPE2 202 occurs.

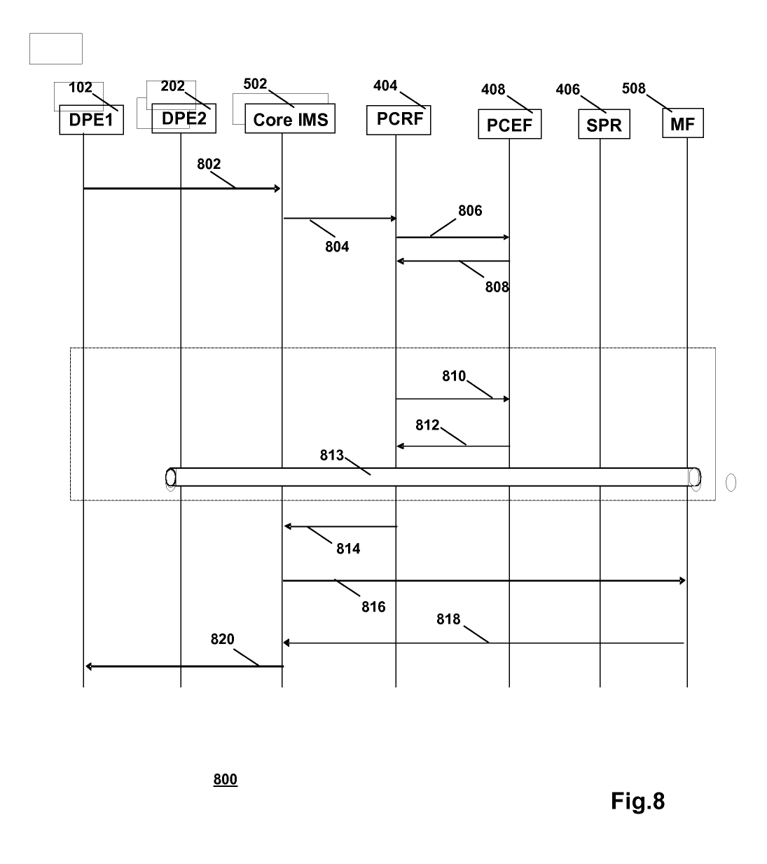

FIG. 8 is a third signaling diagram 800 illustrating the invention with reference to the flow of messages in the system 500 involved in the media control and media delivery, in case the first user turns off his DPE1 102. In a step 802, the DPE1 102 sends a session termination request to the Core IMS 502. In a step 804, the Core IMS 502 releases the resources by sending a message to the PCRF 404. In a step 806, the PCRF 404 sends a resource release message to the PCEF 408. In a step 808, the PCEF 408 sends to the PCRF 404 a confirmation message of the release of bandwidth. Thereafter, the PCRF 404 starts a decision process. More bandwidth is now available. Note that the media stream received by the DPE2 202 is below the maximum bandwidth requested. That is, the stream to the DPE2 202 is currently not using all enhancement layers available in the second video encoded in a layered coding scheme. The PCRF 404 takes a decision based on the applicable policy. In a step 810, the PCRF 404 instructs the PCEF 408 with a resource modification message to stop blocking certain enhancement layers of the second video to the DPE2 202. The PCEF 408 obeys and confirms this in a step 812 by sending to the PCRF 404 a resource confirmation message. Accordingly, the quality of the second video, as perceived by the second user, increases. A stage has then been reached, wherein the number is increased of layers in the media delivered to the DPE2 202. This stage is indicated between the step 812 and a step 814 and with a reference numeral 813. Next steps 814, 816, 818 and 820 are conventional steps in a procedure to terminate the session of the DPE1 102. In the step 814, the PCRF 404 confirms to the Core IMS 502 the release of the resources that had been reserved for the DPE1 102. In the step 816, the Core IMS 502 sends a request to the MF 508 to terminate the session of the DPE1 102. In the steps 818 and 820, the MF 508 confirms the termination to the DPE1 102 via the Core IMS 502.

Above discussion of FIGS. 5-8 relates to an IMS network, an example of a managed network. The invention can also be implemented in services provided in other managed networks wherein, similarly to what has been discussed with respect to the IMS architecture, the end-users are known in advance, and wherein access to the network, as well as the communication via the network, are controlled. Such other managed networks likewise have functions that correspond to the ones discussed with reference to the IMS architecture: a first function corresponding to the SPR 406 that stores the end-user profiles such as information about individual addresses and subscriptions, log-in codes, access rights, etc; a second function corresponding to PCRF 404 of the IMS architecture, for determining a policy control function in order to decide on QoS management issues; and a third function corresponding to the PCEF 408 in the IMS architecture, for enforcing the policies determined by the second function.

Above discussion relates to a first example implementation of the invention regarding dynamic, layer-aware, bandwidth management using the standardized Policy and Charging Control (PCC) in the QoS infrastructure of the IMS architecture in an IPTV context. Now the second example implementation of the invention will be discussed. The second example dynamically manages bandwidth based on RTSP snooping in the access node 106.

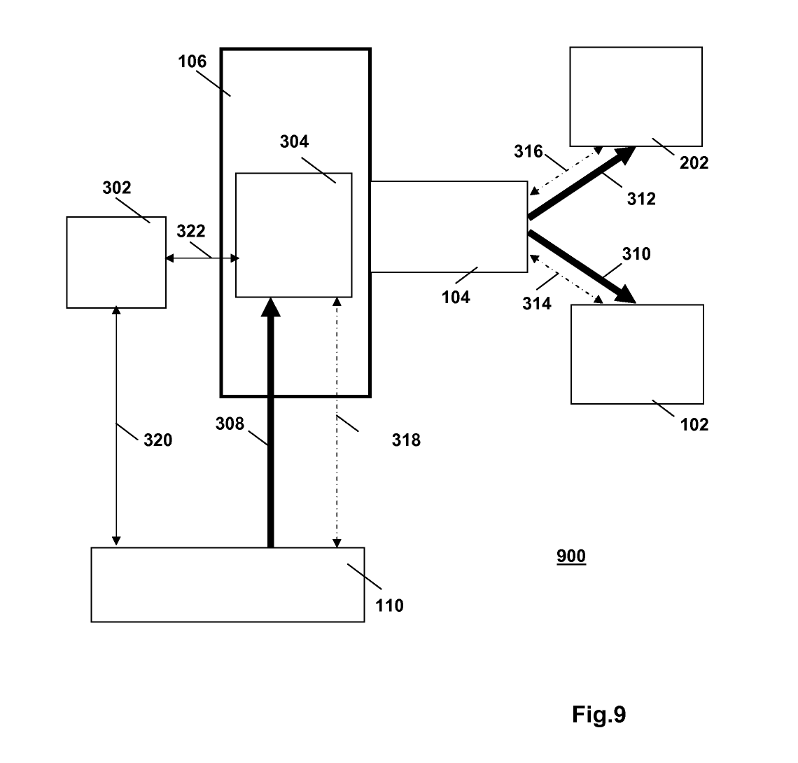

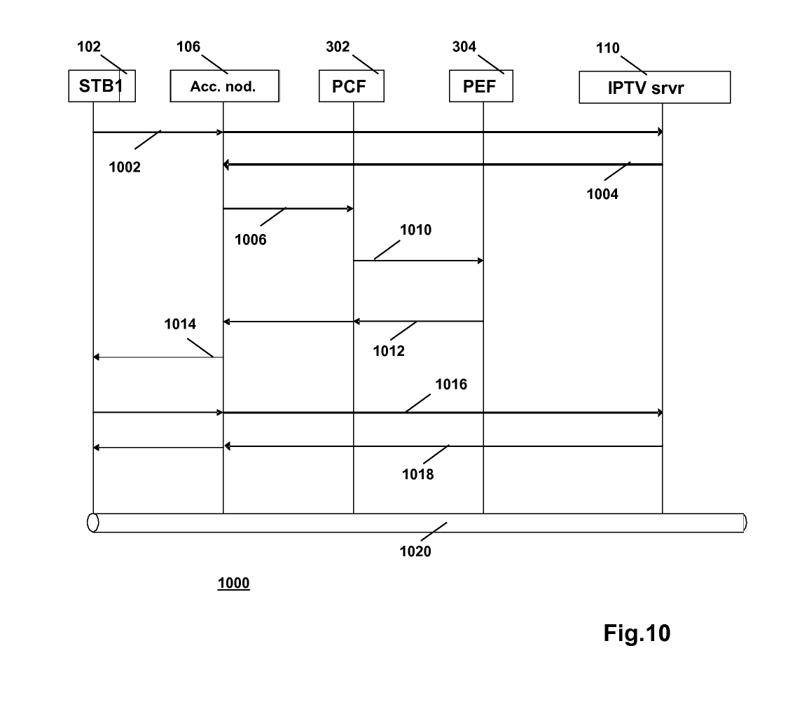

FIG. 9 is a block diagram of a system 900 illustrating the second example implementation of the invention, which uses RSTP snooping and wherein a service provider manages IPTV streaming sessions. The system 900 is a variation on the system 300 discussed with reference to FIG. 3. Please see FIG. 3 and the accompanying description for the corresponding features. The system 900 comprises the first data processing equipment 102, here a first STB, and the second data processing equipment 202, here a second STB, that receive content information via the shared data connection 104 from the IPTV server 110 via the access node 106. Bandwidth of the data connection 104 between, on the one hand, the first STB 102 and the second STB 202 and, on the other hand, the access node 106, is limited. Operation of the system 900 is illustrated with the following use case. The first user of the first STB 102 starts watching a TV channel in his/her household via his/her first STB 102. After a while a second user of the second STB 202 starts watching a different TV channel in his/her household on his/her second STB 202. In order to explain the operation of the system 900, reference is now had to a message flow diagram 1000 of FIG. 10.

FIG. 10 is a first message flow diagram 1000 to illustrate the operation of the system 900. In a first step 1002, the first STB 102 requests an IPTV channel from IPTV streaming server 110 by means of sending an RTSP request via the access node 106. The IPTV streaming server 110 responds in a step 1004 by sending an RTSP response with an SDP description to the access node 106. In the access node 106, the RTSP protocol messages containing SDP descriptions are snooped, e.g., the RTSP response from the IPTV streaming server 110 in the step 1004 is snooped. In a step 1006, the access node 106 forwards the contents, e.g., an SDP description, of the snooped message to the policy control function 302, which is implemented in, e.g., the access node 106 itself or in a different device. The policy control function 302 logs the session and, based on the bandwidth characteristics of the data connection 104, the policy control function 302 determines that enough bandwidth is available to support the streaming session. Accordingly, enforcement of a bandwidth-limiting policy is not required. Thereafter, in a step 1010, the policy control function 302 notifies the policy enforcement function 304 of the requested resources by sending a resource request message. This message comprises information about, e.g., the port numbers that should be opened for delivery of the stream from IPTV server 110 to first STB 102. The monitoring of the availability of bandwidth is provided by, e.g., the access node 106 or by the policy control function 302. After this set-up, the policy control function 302 is aware of the session between the first STB 102 and the IPTV streaming server 110, and of the content information of the IPTV video streams. For example, the policy control function 302 has information about the number of enhancement layers used; the manner of identifying individual layers; and about the way wherein the layers are being transmitted. In a step 1012, the policy enforcement function 304 confirms, via the policy control function 302 to the access node 106, the allocation of resources for the session as requested in the step 1002. Upon this confirmation, the access node 106 sends the RTSP response to the STB 102 in a step 1014. In a step 1016, the first STB 102 sends an RSTP message via the access node 106 to the IPTV streaming server 110, to inform the IPTV streaming server 110 that the streaming can be started. The IPTV streaming server 110 confirms in a step 1018 with an RSTP message that the streaming will be started, after which a stage 1020 has been reached wherein media is streamed to the first STB 102.

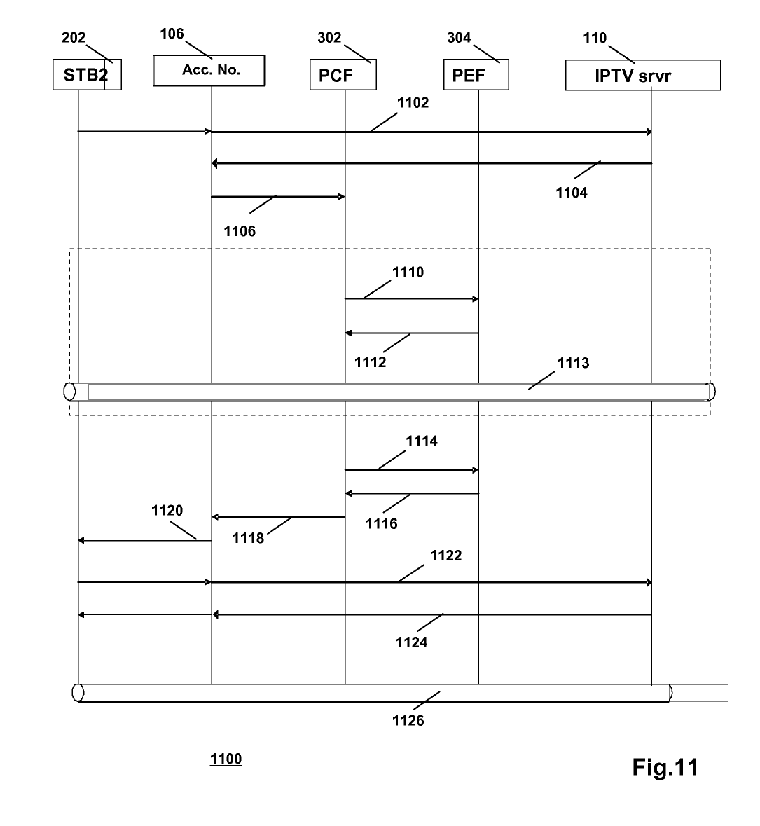

FIG. 11 is a message flow diagram 1100 illustrating the message flow in the system 900 when the second STB requests an IPTV channel via RTSP from the IPTV streaming server 110. In a step 1102, the second STB 202 sends an RTSP request, via the access node 106, to the IPTV streaming server 110 requesting a TV channel. The access node 106 is snooping this RTSP request. In a step 1104, the IPTV streaming server 110 sends an RSTP response with an SDP description to the access node 106. In a step 1106, the access node 106 forwards the contents of the RTSP response, received from the IPTV streaming server 110, to the policy control function 302. The policy control function 302 then determines that there is insufficient bandwidth available at the data connection 104 for support in the IPTV session of the first STB 102 as well as the IPTV session of the second STB 202. Therefore, the policy control function 302 decides what needs to happen according to a pre-determined policy. The policy control function 302 determines that the access node 106 should drop certain layers destined for the first STB 102 and notifies in a step 1110 the policy enforcement function 304 of this resource modification for the first STB 102. In a step 1112, the policy enforcement function 304 confirms to the policy control function 302 the reallocation of resources, here: bandwidth. A stage 1113 has then been reached, wherein the freed-up bandwidth has become available to provide the requested service to the second STB 202. The remaining steps shown in the diagram 1100: steps 1114, 1116, 1118, 1120, 1122 and 1124 are known steps of a known message flow to set up the session for the second STB 202. In the step 1114, the policy control function 302 requests from the policy enforcement function 304 the allocation of resources. In the step 1116 the policy enforcement function 304 confirms the resource allocation to the policy control function 302. In the step 1118, the policy control function 302 confirms the session to the access node 106. In the step 1120, the access node 106 notifies the second STB 202 via an RTSP message. In the step 1122, the second STB 202 sends an RTSP request, via the access node 106 to the IPTV server 110, for the play-out of the program on the IPTV channel specified in the step 1102. In the step 1124, the IPTV server 110 sends an RTSP message confirming the play-out. Then, a stage has been reached, referred to with reference numeral 1126, wherein the requested media is delivered to the second STB 202.

An alternative implementation of RTSP snooping is using an RTSP proxy server (not shown) between the STB 202 and the IPTV server 110. Then, the STB 202 does not connect directly to the IPTV server 110, but connects to the IPTV server 110 via the RTSP proxy server. The RTSP proxy is located, e.g., at the access node 106, or someplace else in the network. The RTSP proxy connects to the IPTV server 110 on behalf of the STB 202 and relays the RTSP messages exchanged between the STB 202 and the IPTV server 110. This gives rise to a first RTSP session and a second RTSP session. The first RTSP session involves the STB 202 and the RTSP proxy server. The second RTSP session involves the RTSP proxy and the IPTV server 110. This enables the RTSP proxy server to modify the messages exchanged between the STB 202 and the IPTV server 110, without the STB 202 or the IPTV server 110 being able to detect this.

Another example of how this invention can be used is applying Dynamic Layer-Aware bandwidth management for a large group of users, for example, all users connected to a Digital Subscriber Line Access Multiplexer (DSLAM). A DSLAM is a network device at a telephone exchange of a service provider. The DSLAM connects multiple customer Digital Subscriber Lines (DSLs) to a high-speed Internet backbone via multiplexing.

IPTV channels are typically distributed in a multicast. The more popular channels are distributed as near to the edge as possible in order to reduce channel start-up time. The other channels are only distributed towards the core network, in order to reduce the waste of bandwidth for channels that are rarely being watched. There is a trade-off between bandwidth consumption on the one hand, and start-up latency on the other.

To improve bandwidth efficiency and/or start-up time, an IPTV service provider (SP) can use Dynamic Layer-Aware bandwidth management for optimum delivery of all TV channels. The SP uses the popularity of a channel to determine in what quality (here: the number of enhancement layers) the TV channels are to be delivered. For popular channels, all enhancement layers are being transmitted. For the other channels, or for the channels that currently do not have any viewers, enhancement layers are removed. This frees up bandwidth for more TV channels or other services, such as telephony (VoIP), Content-on-Demand services, or best-effort Internet services.

The SP is capable of monitoring what the users are watching. For example, the SP can snoop or sniff IGMP join group messages. An STB sends such a message to subscribe to a multicast group. The SP translates the multicast address to the TV channel that is distributed to the multicast group. Alternatively, the SP can sniff RTSP requests. An RTSP request contains the TV channel identifier and, optionally, SDP descriptions that provide the channel name and multicast addresses. As yet another alternative, the SP can use SIP (IMS) session control information in order to determine the channels that are being watched. Based on this information, the SP can dynamically determine the amount of bandwidth per channel (i.e., the number of layers).

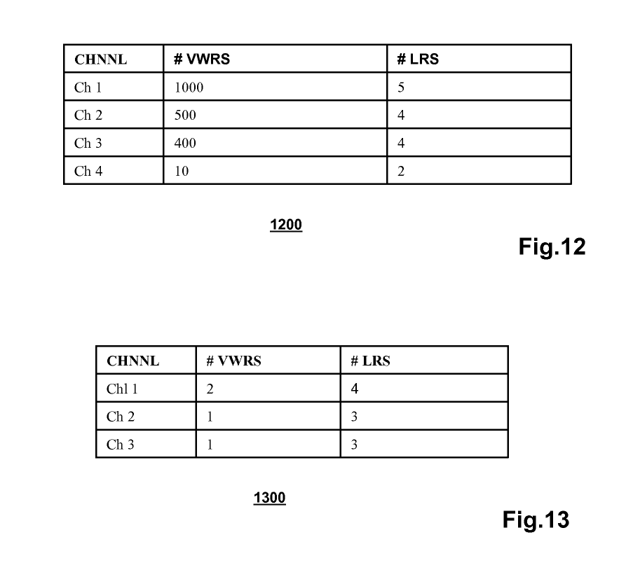

Consider the following example. The total core link bandwidth is 15 Mbps. The minimum bandwidth requirement per channel is 2 Mbps. The maximum bandwidth requirement per channel is 5 Mbps. FIG. 12 gives a table 1200 with a possible distribution of bandwidth (i.e., the number (#LRS) of layers) among a plurality of channels (CHNNL): channel Ch 1; channel Ch 2; channel Ch 3; and channel Ch 4) given the number of current viewers (# VWRS) per individual channel (current popularity).

Consider the following example, now regarding a single household. Total access link bandwidth is 10 Mbps. The minimum bandwidth per channel is 3 Mbps. The maximum bandwidth per channel is 5 Mbps. FIG. 13 gives a table 1300 with the number of layers per TV channel received in a single household. The number of viewers can be determined via, e.g., session setup or negotiation messages (SIP or RTSP), via transmission feedback messages (RTCP receiver reports) or via management messages (i.e. an STB periodically reports to the Service Provider which channel it is currently showing). This can, for instance, be done with SOAP messages or a proprietary implementation. The acronym “RTCP” stands for “RTP Control Protocol”, which is a protocol for providing out-of-band statistics and control information for an RTP flow. The acronym “SOAP” stands for “Simple Object Access Protocol” and refers to a protocol specification for exchanging structured information in the implementation of web services in data networks.

The previous use cases focus on delivery of TV channels from an SP to the end-user. The invention can also be applied to services, wherein users are broadcasting content information. For example, a user initiates a video broadcast or video conference using a scalable video codec. Initially the upload-bandwidth is capable of transmitting a 2 Mbps video stream. At a certain moment, a second user wishes to upload another video stream. As there is insufficient bandwidth available in the uplink direction, the policy control server decides to limit the uplink of the stream for the first user by dropping enhancement layers. This frees up resources for the second video stream.

The principle of providing the best service (in terms of allocating the most enhancement layers to the most popular content information), can also be applied to end-user broadcasts. For example, the end-user with the highest number of subscribed receivers will be allowed to transmit all layers. Less popular broadcasts will transmit fewer layers. For example, a first user and a second user are broadcasting to the Internet from their respective home networks. The upload bandwidth for the first user and second user combined is 3 Mbps. The bandwidth allocation is controlled by the Internet Service Provider (ISP) of both the first user and second users and controls the upload connections from the access network or the core network. Assume that the broadcast from the first user is watched by hundred viewers, whereas the broadcast from the second user is being watched by ten viewers. Based on the respective numbers of viewers (i.e., popularity), the ISP allocates a first bandwidth of 2 Mbps to the broadcast of the first user and a second bandwidth of 1 Mbps to the second user. Accordingly, the quality of the first user's broadcast is higher than that of the second user's broadcast. If, during the broadcasts, the number of viewers of the broadcast from the second user increases to, say, one thousand, the ISP can re-allocate the bandwidth so as to assign a first bandwidth of 1 Mbps to the broadcast from the first user and a second bandwidth of 2 Mbps to the broadcast from the second user. The magnitude of the bandwidth allocated per individual broadcast determines which enhancement layers are dropped or added. In this case, the residential gateway is part of the managed network and will provide the gating function (i.e., the residential gateway implements the policy enforcement function).

The policies define what actions should be taken when data processing equipment requests from a service the delivery of content information encoded in a layered coding scheme. For example, a policy may specify that enhancement layers be dropped to allow other data processing equipment to be serviced, or that the dropped layers be added when resources are freed.

An important aspect in the decision-making process, based on the applicable policy, is to determine what can be removed and what not. This information can be provided in advance (i.e. provided by the service provider) or can be generated during session establishment, as the data processing equipment also needs to be informed about the relation between the different layers and the transport of the layers (for instance with SDP descriptions).

Examples of different types of policy criterions are the following. The criterion is time-based: resources are allocated based on the time of the day. The time of the day determines if, and how many, layers can be removed. The criterion is popularity-based: gating is controlled by the popularity of the content information (e.g., the current number of subscribers). The criterion is content-based: the content information being distributed determines the policy regarding removal of layers. The metadata accompanying the content information determines the eventual removal of layers.

Specific embodiments of the invention have been discussed above by way of example, and with reference to the transport of the content information using RTP. As is clear, RTP is only one of a group of transport protocols, suitable for the delivery of layered content information. The base layer and one or more enhancement layers can be delivered as a collection of separate, individual data streams, or as a single data stream resulting from the multiplexing of the data of the base layer and of one or more enhancement streams. In both cases, the invention needs a filtering mechanism during the transport of the layered content information for filtering out the data that makes up one or more individual ones of the layers. Suitable transport protocols, as alternatives to RTP, are, for example, HTTP, UDP, TCP, or peer-to-peer (P2P) content delivery protocols such as Bittorrent. For completeness, the acronym “HTTP” stands for “Hypertext Transfer Protocol”, and refers to an application-level protocol for the distribution of multimedia over the Internet. The acronym “UDP” was introduced at an earlier stage above. The acronym “TCP” stands for “Transmission Control Protocol” and refers to a transport layer protocol that is included in the core of the Internet protocol suite. The name “Bittorrent” refers to a specific file-sharing protocol on a P2P network.

1. A method of allocating an amount of bandwidth to a transport of content information as data via a data connection wherein:
the content information is encoded in a layered coding scheme,
the layered coding scheme uses a base layer and one or more enhancement layers; and
the method comprises:
determining if the data connection is in use for a further transport of further content information as further data via the data connection;
determining one or more further attributes of the further transport; and
determining a number of the one or more enhancement layers of the content information for the transport under control of a pre-determined policy depending on the one or more further attributes of the further transport,
allocate an amount of bandwidth to the transport of content information in dependence of the number of enhancement layers of the content information.

2. The method of claim 1, wherein:
the further content information is encoded in a further layered coding scheme;
the further layered coding scheme uses a further base layer and one or more further enhancement layers;
the method comprises adjusting a further amount of bandwidth of the further transport; and
the adjusting comprises:
determining one or more attributes of the transport;
determining a further number of the one or more further enhancement layers of the further content information in the further transport under control of a pre-determined further policy depending on the one or more attributes of the first transport
adjusting the further amount of bandwidth of the further transport in dependence of the number of enhancement layers of the content information.

3. The method of claim 1, wherein the further attribute includes one or more of the following:
a further relative popularity of the further content information with respect to the content information;
a further semantic aspect of the further content information;
a further destination of the further data representative of the further content information;
a further source of the further data representative of the further content information;
a time of the day of initiating the transport of the further content information; and
a further identity of a further end-user of the further content information.

4. The method of claim 2, wherein the attribute includes one or more of the following:
a relative popularity of the content information with respect to the further content information;
a semantic aspect of the content information;
a destination of the data representative of the content information;
a source of the data representative of the content information;
a time of the day of initiating the transport of the content information; and
an identity of an end-user of the content information.

5. The method of claim 1, wherein:
the content information is provided via an infrastructure of a managed network;
the infrastructure comprises a Policy Control Function for selecting the predetermined policy, and a Policy Enforcement Function for enforcing the pre-determined policy; and
the method comprises controlling the number of the one or more enhancement layers via the Policy Enforcement Function using gating of the one or more enhancement layers as indicated by the Policy Control Function.

6. The method of claim 5, wherein:
the infrastructure comprises a Subscription Profile Repository; and
the Policy Control Function is enabled to indicate the one or more enhancement layers under control of the Subscription Profile Repository.

7. The method of claim 5, wherein:
the content information is provided by a server in an Internet Protocol Television (IPTV) service;
the data connection has an access node;
the access node is configured for snooping on at least one of
(i) a request, sent via the access node to the server, for the content information, and
(ii) a response from the server to the request for the content information;
the access node is configured for forwarding a content of the response to the Policy Control Function.

8. The method of claim 5, wherein:
the content information is provided, via a proxy server, by a server in an Internet Protocol Television (IPTV) service;
the proxy server is configured for snooping on at least one of:
(i) a request, sent via the proxy server to the server in the IPTV service, for requesting the content information, and
(ii) a response from the server in the IPTV service to the request for the content information, wherein the response is sent via the proxy server; and
the proxy server is configured for forwarding a content of the response to the Policy Control Function.

9. The method of claim 2, wherein:
the further content information is provided via an infrastructure of a managed network the infrastructure comprises a Policy Control Function for selecting the pre-determined policy, and a Policy Enforcement Function for enforcing the pre-determined policy; and
the method comprises controlling the number of the one or more further enhancement layers via the Policy Enforcement Function using gating of the one or more further enhancement layers as indicated by the Policy Control Function.

10. The method of claim 9, wherein:
the infrastructure comprises a Subscription Profile Repository; and
the Policy Control Function is enabled to indicate the one or more further enhancement layers under control of the Subscription Profile Repository.

11. The method of claim 9, wherein:
the further content information is provided by a server in an Internet Protocol Television (IPTV) service; the data connection has an access node;
the access node is configured for snooping on at least one of:
(i) a further request, sent via the access node to the server, for the further content information; and
(ii) a further response, from the server to the further request for the further content information; and
the access node is configured for forwarding a further content of the further response to the Policy Control Function.

12. Control software on a computer readable medium for control of allocating an amount of bandwidth to a transport of content information as data via a data connection wherein:
the content information is encoded in a layered coding scheme the layered coding scheme uses a base layer and at least one enhancement layer; and
the control software comprises:
first instructions for determining if the data connection is in use for a further transport of further content information as further data via the data connection;
second instructions for determining one or more further attributes of the further transport;
third instructions for determining a number of the one or more enhancement layers of the content information for the transport under control of a pre-determined policy depending on the one or more further attributes of the further transport; and
fourth instruction for allocating an amount of bandwidth to the transport of content information in dependence of the number of enhancement layers of the content information.

13. A data processing system, configured for control of allocating an amount of bandwidth to a transport of content information as data via a data connection before initiating the transport, wherein:
the content information is encoded in a layered coding scheme;
the layered coding scheme uses a base layer and at least one enhancement layer; and
the data processing system comprises:
first means for determining if the data connection is in use for a further transport of further content information as further data via the data connection;
second means for determining one or more further attributes of the further transport; and
third means for determining a number of the one or more enhancement layers of the content information for the transport under control of a pre-determined policy depending on the one or more further attributes of the further transport;
fourth means for allocating an amount of bandwidth to the transport of content information in dependence of the number of enhancement layers of the content information.
